(19) United States
(12) Patent Application Publication
(10) Pub. No.: US 2009/0143968 A1
(43) Pub. Date: Jun. 4, 2009

(54) Perceptual-Spatial Electronic Flight Data Interface for airport traffic control towers

(75) Inventor: Todd Richard Truitt, Egg Harbor Township, NJ (US)

Correspondence Address: Martin E. Robinson, Jr.;Federal Aviation Administration, AGC-500, 800 Independence Ave. SW, Washington, DC, 20591, US

(73) Assignee: Government of the United States, Washington, DC (US)

(21) Appl. No.: 11/987,296

(22) Filed: Nov. 29, 2007

(51) Int. Cl. G08G 5/00; G08G 5/06; G06F 3/048

(52) U.S. Cl. 701/120

(57) ABSTRACT

In an air traffic control system, a method to track, record, communicate, and organize electronic flight data spatially in relation to an airport surface.

### STATEMENT OF GOVERNMENT INTEREST

The present invention may be made or used by or for the Government of the United States without the payment of any royalties thereon.

### FIELD OF THE INVENTION

The disclosed invention is directed generally to airport traffic control systems, and more particularly to an interactive airport traffic control tower graphical user interface.

### BACKGROUND OF THE INVENTION

Projected increases in air traffic along with modernization efforts have led the Federal Aviation Administration (FAA) to consider replacing paper Flight Progress Strips (FPSs) with an electronic alternative. Electronic Flight Data (EFD) alternatives have the potential to increase a controller's ability to acquire, track, and record information as well as communicate and coordinate that information with others. Paper FPSs have been used by certified air traffic controllers (hereinafter referred to simply as controllers) since the 1930s and 1940s. The FPS has become a historical artifact that limits the usefulness of flight data and consumes valuable cognitive resources.

In today's Airport Traffic Control Tower (ATCT) environment, controllers must manually update information, record clearances, and physically pass FPSs from one controller to another. Controllers must also mentally correlate the flight data information on the FPSs with the aircraft on the airport surface. As the aircraft move across the airport surface, the controller must continually update his/her mental picture of the traffic situation and the associated flight data. All of these activities require cognitive and sensory resources that may be relieved by automation or other less subtle changes in standard operating procedures. The inherent physical limitations of FPSs restrict the controllers' ability to communicate flight data information with other facilities such as the Terminal Radar Approach Control (TRACON), Air Route Traffic Control Center (ARTCC), and Airline Operations Center (AOC). Currently, controllers must perform most communication and coordination between the ATCT and other facilities via a telephone landline.

In some instances, controllers can pass FPSs from the ATCT to the TRACON with a gravity-fed drop tube. However, with the modernization of FAA facilities and the advent of the Electronic Flight Strip Transfer System (EFSTS), drop tubes are becoming outdated. Bar code scanners located at the controllers' workstation and bar codes printed on each FPS enables the EFSTS. Although the EFSTS allows the electronic transfer of information between remote facilities, the EFSTS has number of limitations. The EFSTS requires the FAA to print duplicate FPSs in multiple locations, for example between the ATCT and the TRACON. Changing or updating FPS information that controllers must pass between the ATCT and TRACON is also difficult or impossible with the EFSTS.

ATCT controllers must also be able to handle a dynamic mental representation of multiple aircraft and their respective positions within the airport operations area. Controllers must work to mentally connect each aircraft to the appropriate information on the FPSs such as identification, aircraft type, expected departure time, and runway assignment. The controllers must exert constant mental effort to update this mental picture and maintain the proper connections between the paper FPSs and the associated aircraft. The failure do so may result in the controller forgetting where an aircraft is located and issuing improper instructions that may result in a runway incursion or collision.

In order to maintain their mental picture of the situation, controllers must often search for a FPS and then record hand-written information on it. The search process can be time consuming and requires the controllers to filter out irrelevant information. Controllers must also exert cognitive effort to remember timing information such as when they must space departure aircraft from wake turbulence. Any hand-written information is not stored in the National Airspace System (NAS) computers, and is inaccessible to decision support tools and other air traffic facilities. Furthermore, each ATCT facility has its own FPS marking guide resulting in a lack of standard procedures. While many towers use unique FPS markings to handle unique situations, hand-written information can be unclear and difficult to read.

### BRIEF DESCRIPTION OF THE DRAWINGS

FIG. 1 shows the hardware used to implement the Perceptual-Spatial Electronic Flight Data Interface (P-S EFDI).

FIG. 2 shows the primary elements of the P-S EFDI.

FIG. 3 shows a pending FDE on the ground controller's EFDI.

FIG. 4 shows outbound FDEs.

FIG. 5 shows departure FDEs on the local control P-S EFDI.

FIG. 6 shows unoccupied and occupied TIPH buttons for two intersecting runways.

FIG. 7 shows the departure clearance button located near the departure end of intersecting runways on the local control P-S EFDI.

FIG. 8 shows FDEs for aircraft the local controller has cleared for departure in the departure list on the local control P-S EFDI.

FIG. 9 shows arrival FDEs in the arrival list on the local control P-S EFDI.

FIG. 10 shows inbound FDEs on the ground control P-S EFDI.

FIG. 11 shows FDE zones on the local control P-S EFDI.

FIG. 12 shows three chains of FDEs on the local control P-S EFDI.

FIG. 13 shows the readout area and information for an arriving aircraft.

FIG. 14 shows the readout area and information for a departing aircraft.

FIG. 15 shows amended altitude and heading assignments as depicted in the readout area.

FIG. 16 shows the system information window and elements.

### SUMMARY OF THE INVENTION

The Perceptual-Spatial Electronic Flight Data Interface (P-S EFDI) provides a means to track, record, communicate, and organize EFD spatially in relation to an airport surface. The P-S EFDI helps controllers to correlate flight data more closely with the actual aircraft they represent. The P-S EFDI creates a physical, observable relationship between real aircraft on the airport surface and their abstract representation in the form of flight data. By strengthening this relationship between flight data and their associated aircraft, the controller's ability is enhanced to spatially organize information, maintain awareness of the traffic situation, remember critical information, and perform more efficiently.

### DETAILED DESCRIPTION OF THE EMBODIMENTS

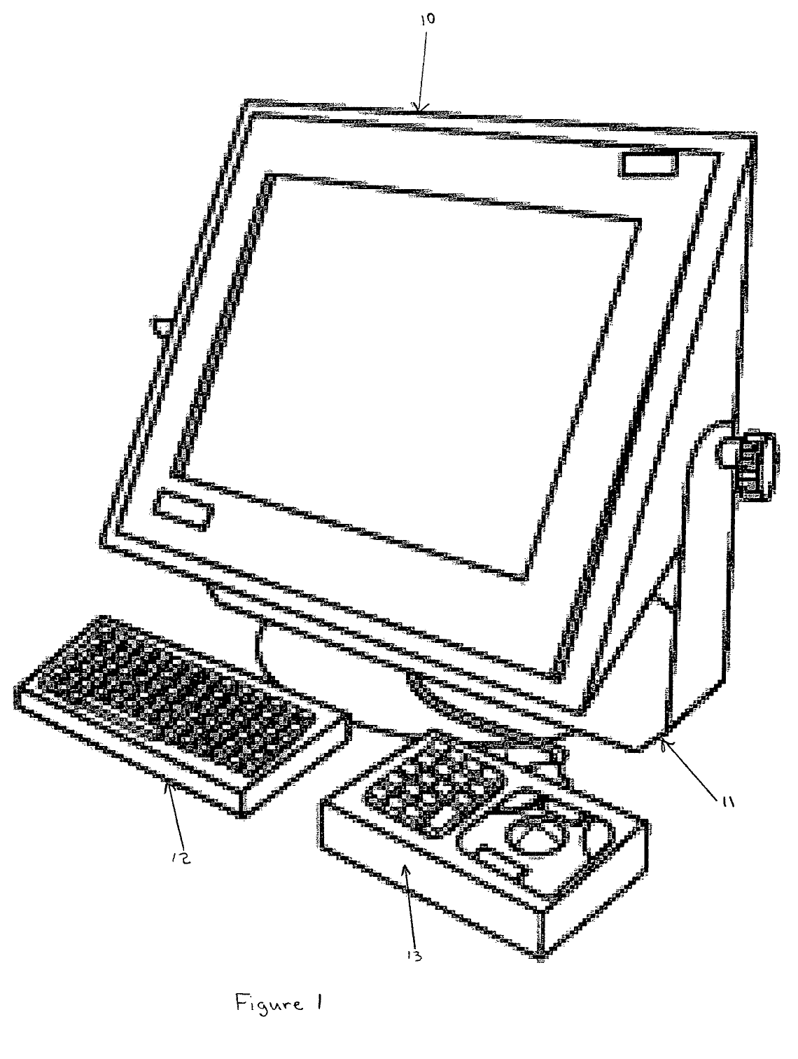

Referring to FIG. 1, the hardware used to implement the P-S EFDI includes a resistive touch sensitive display 10, display mount 11, keyboard 12, and a trackball/keypad combination 13. In the preferred embodiment, the display is a VarTech Systems, Inc. touch sensitive display. This VarTech Systems, Inc. touch sensitive display is a 21.3-inch display that provides an active display area that is 17-inches (432 mm) wide and 12.75-inches (324 mm) high which provides a 1600×1200 pixel format with a viewing angle of 85 degrees. This display uses resistive technology to enable a touch screen that can be activated by either a stylus or by a person's fingertip. This display is mounted on a display mount 11 that supports the weight of the display and allows the user to adjust the horizontal and vertical viewing angle. In the preferred embodiment an Airport Surface Detection Equipment-Model X (ASDE-X) keyboard and ASDE-X trackball/keypad combination were used for the keyboard 12 and the trackball/keypad combination 13.

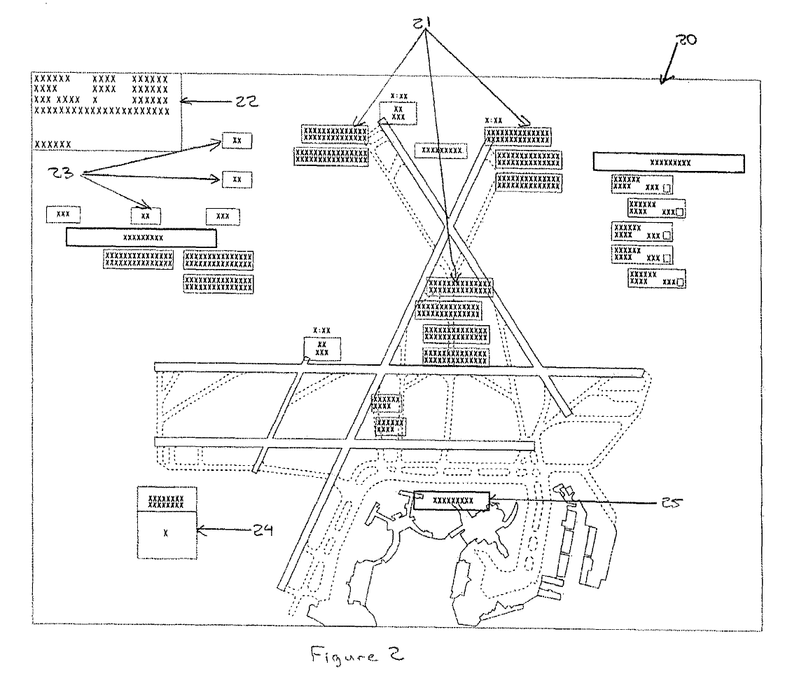

The P-S EFDI is comprised of two separate interfaces, one for the ground controller and one for the local controller, to accommodate the information and task requirements of each position. Referring to FIG. 2, the primary elements common to both the ground and local control positions include the airport surface map 20, flight data elements (FDEs) 21, the readout area 22, buttons 23, system information window 24, and reminders.

FDEs 21 occupy space on the airport surface map 20 and the controller can visually categorize them by their color, shape, location, and flight data attributes. FDEs include different types for pending, outbound, inbound, arrival, and departure aircraft. The controller can move each FDE 21 and place it on the airport surface map 20. Placing a FDE in certain areas of the map has different effects including time records and highlighting. Outbound, inbound, departure, and arrival FDEs appear on both the ground and local controller positions. Pending FDEs only appear on the ground controller's position. Although many of the FDEs appear on both the ground and local controllers' displays, the FDEs do not appear the same on both displays. In the preferred embodiment, FDEs that are in possession of a controller appear with white text and borders, but pending FDEs or FDEs possessed by another controller appear with gray text and borders. Except for pending FDEs on the ground controller's interface, a controller can only move FDEs that are in their own possession. This rule preserves the FDE's usefulness for communicating information about aircraft location and prevents controllers at different positions from interfering with each other's actions.

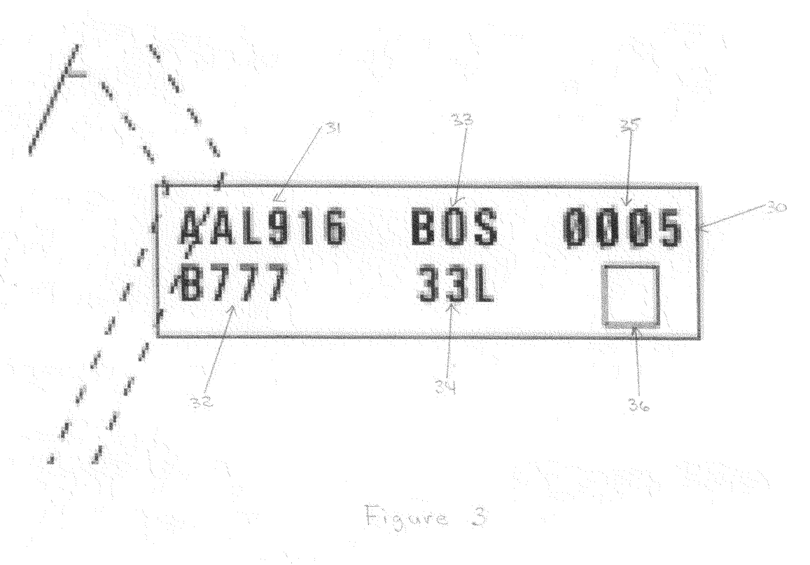

Referring to FIG. 3, pending FDEs 30 are for departing aircraft that are waiting on the ramp. A pending FDE 30 contains the flight data attributes of the aircraft call sign 31, aircraft type 32, first departure fix 33, runway/intersection assignment 34, and proposed departure time 35. A pending FDE may also contain an Estimated Departure Clearance Time (EDCT) instead of a proposed departure time and an Automatic Terminal Information Service (ATIS) update indicator 36. In the preferred embodiment, pending FDEs appear on their designated ramp spot with gray text and borders to indicate to the ground controller that he has not yet contacted the aircraft. Pending FDEs only appear on the ground controller's EFDI. The ground controller must move a pending FDE when he makes initial contact with the aircraft and provides a departure taxi clearance.

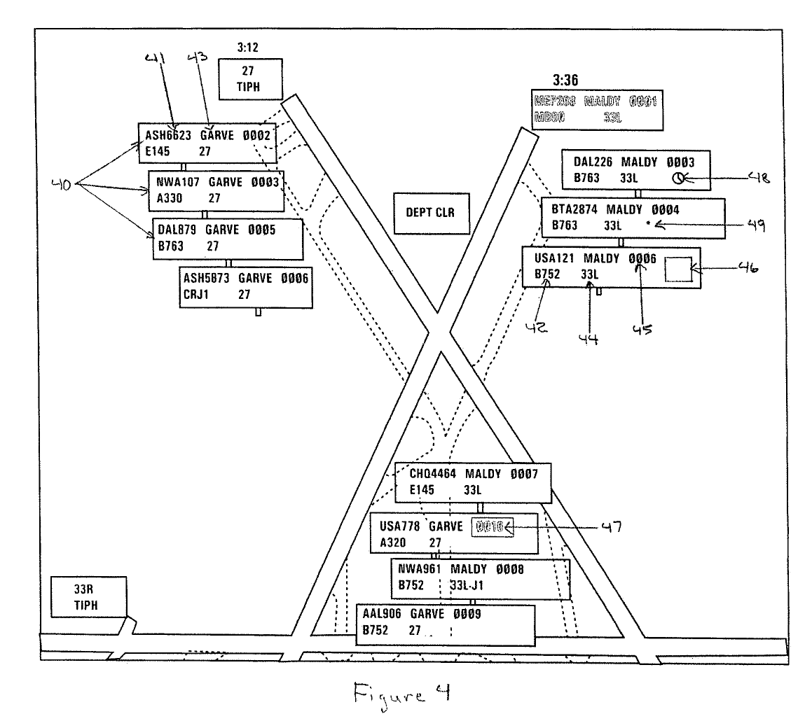

When the controller moves an FDE out of the ramp area onto the airport surface map it becomes an outbound FDE. Referring to FIG. 4, an outbound FDE 40 contains the flight data attributes of the aircraft call sign 41, aircraft type 42, first departure fix 43, runway/intersection assignment 44, and assigned taxi time 45. An outbound FDE may also contain an EDCT in lieu of taxi time 47, ATIS update indicator 46, and flight data amendment indicator 49 or timer indicator 48. In the preferred embodiment, the EFDS automatically assigns and records a taxi time and the FDE text and border changes from gray to white when the ground controller moves an FDE out of the pending state. To transfer an outbound FDE to the local controller, the ground controller selects the FDE and then selects the local controller button. This causes the FDE on the ground controller's interface to display with gray text and border and the associated FDE on the local controller's departure list will display with white text and border.

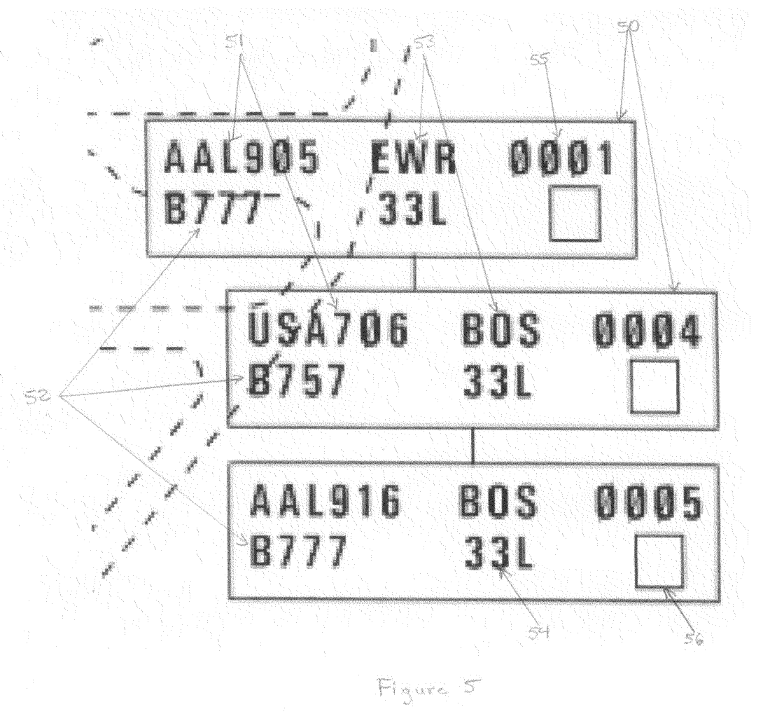

In the preferred embodiment, departure FDEs appear white on the local controller's EFDI and gray on the ground controller's EFDI. Referring to FIG. 5, a departure FDE 50 contains the flight data attributes of aircraft call sign 51, aircraft type 52, first departure fix 53, runway/intersection assignment 54, and assigned taxi time 55. A departure FDE may also contain an EDCT in lieu of taxi time, ATIS update indicator 56, and flight data amendment indicator or timer indicator as shown in FIG. 4.

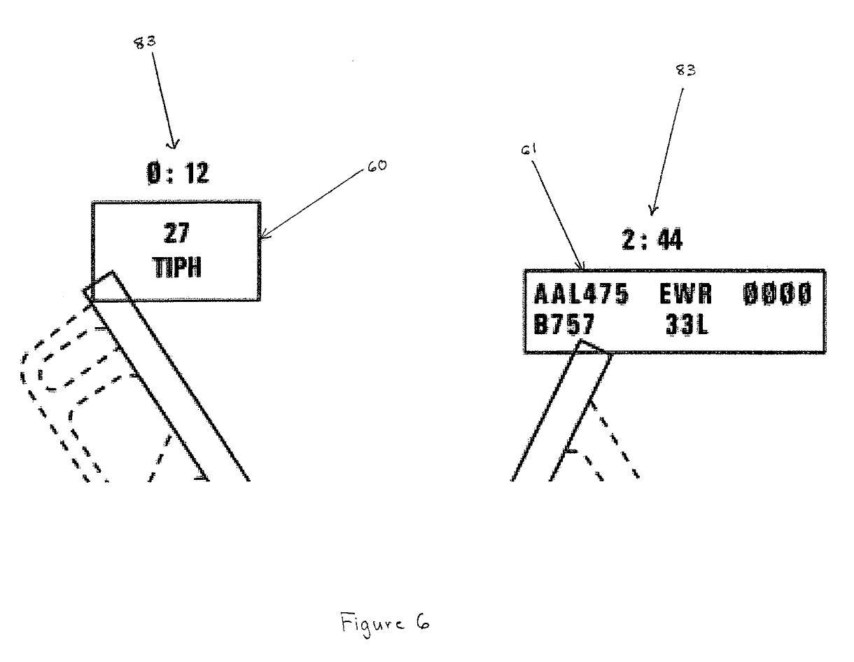

As shown in FIG. 6, a controller can indicate a Taxi-Into-Position-and-Hold (TIPH) clearance by selecting a FDE and then selecting the appropriate TIPH button 60. To prevent the controller from placing a FDE on the wrong runway, the controller can only select the TIPH button that matches the aircraft's runway assignment as indicated in the FDE. When the controller indicates a TIPH clearance, the FDE 61 occupies the location of the appropriate TIPH button and displays with orange text in the preferred embodiment to remind the controller that an aircraft is occupying the departure end of the runway. The FDE border retains the appropriate color indicating possession (i.e., gray or white).

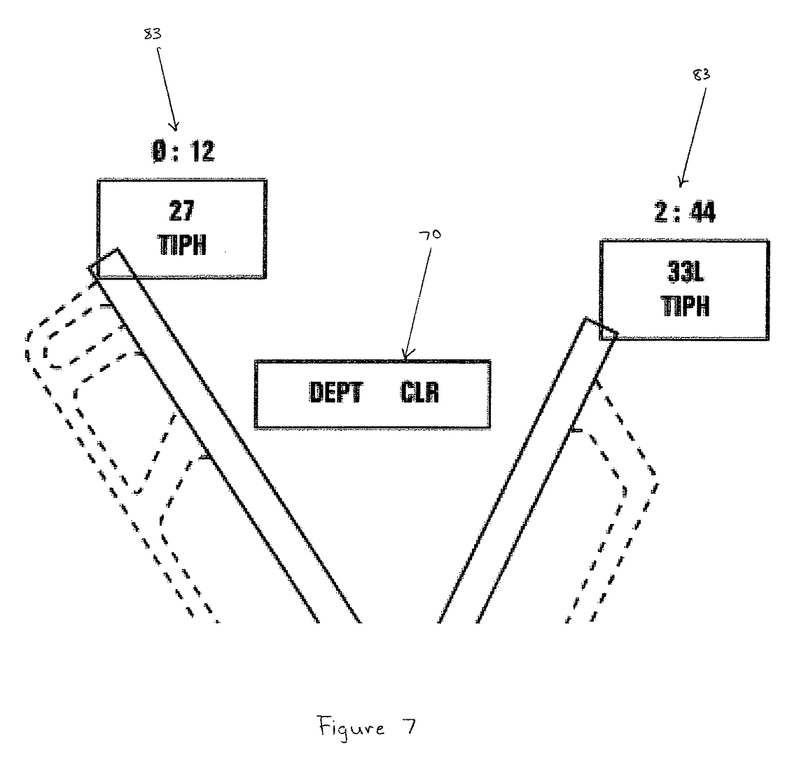

Referring to FIG. 7, when the local controller clears an aircraft for departure, the controller selects the appropriate FDE and then selects the departure clearance button 70. Because only the local controller can clear an aircraft for TIPH or departure, the TIPH and departure clearance buttons only appear on the local controller's EFDI.

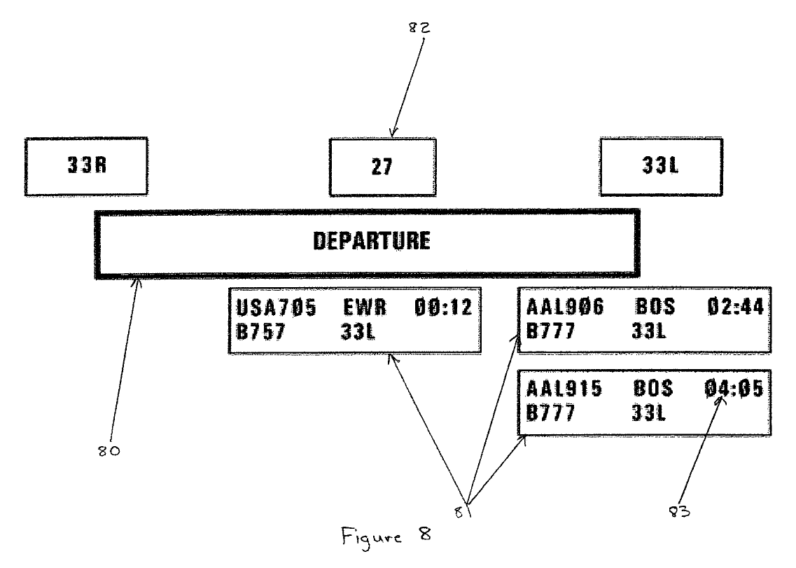

Referring to FIG. 8, assigning a departure clearance to a FDE causes the P-S EFDI to automatically assign a departure time for that aircraft and the FDE 81 occupies the departure list 80 beneath the appropriate runway assignment button 82. Once the local controller clears an aircraft for departure and takes the appropriate FDE action, the FDE 81 in the departure list 80 displays a runway spacing timer 83 in the FDE time field. The runways spacing timer 83, displayed in minutes and seconds (mm:ss), begins incrementing as soon as the FDE occupies the departure list 80. The runway spacing timer 83 assists the controller in determining proper aircraft spacing for separation from wake turbulence caused by preceding departing aircraft.

When the P-S EFDI assigns a departure time to an aircraft, a runway spacing timer 83 appears above the TIPH button for the appropriate runway as shown FIGS. 6 and 7 to indicate the time since the last aircraft departed from that runway. The runway spacing timer indicates minutes and seconds (mm:ss) and counts up from zero to five minutes. The runway spacing timer disappears once it reaches five minutes to prevent the display of extraneous data. The runway spacing timer resets and begins counting up from zero again when the local controller clears the next aircraft to depart from the same runway.

Referring to FIG. 8, the controller can transfer a departure FDE to the TRACON departure controller by selecting a FDE and then selecting the departure header 80 in the departure list. Transferring a departure FDE to the TRACON causes the FDE to disappear from the local controller's EFDI.

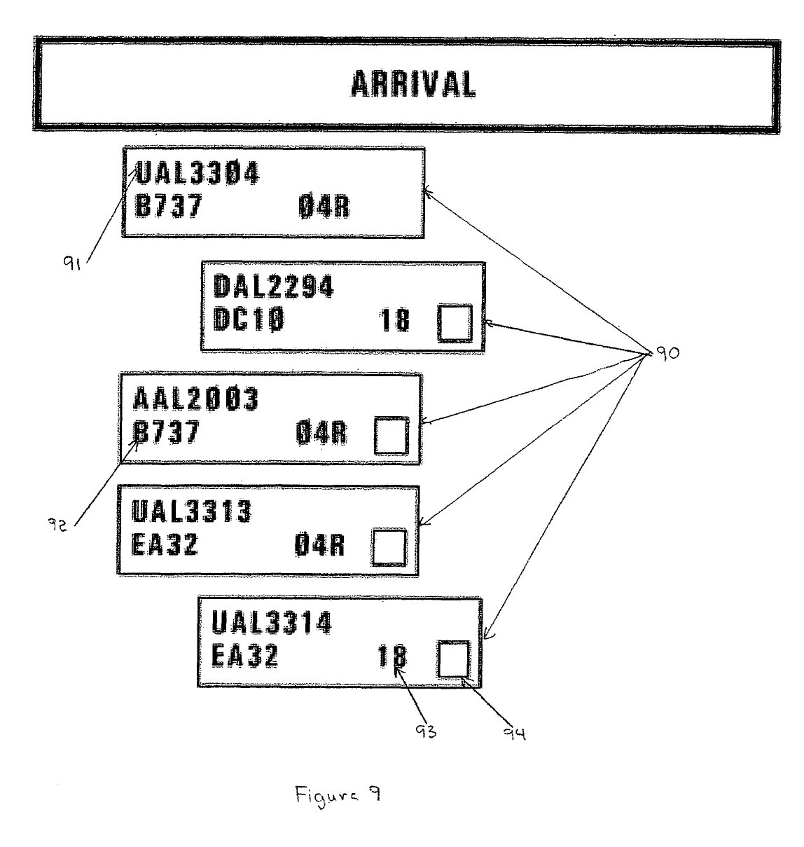

Referring to FIG. 9, arrival FDEs 90 appear in an arrival list on the airport surface map. The FDEs 90 enter at the top of the list and are ordered by time sequence over the outer marker. In the preferred embodiment, arrival FDEs 90 appear with white text and border on the local controller's EFDI and with gray text and border on the ground controller's EFDI. Arrival FDEs 90 contain the flight data attributes of aircraft call sign 91, aircraft type 92, runway assignment 93, ATIS update indicator 94, and may also include a flight data amendment indictor or timer indicator as shown in FIG. 4. The FDEs for aircraft assigned to land on different runways automatically offset from one another in the arrival list. Offsetting FDEs in this manner replicates the way controllers use FPSs and provides an obvious visual indicator of aircraft landing on different runways that may intersect. The controller can change the sequence of the arrival FDEs by selecting a FDE and dragging it to a new location within the arrival list.

Once an aircraft has landed, the local controller can drag the aircraft's FDE to the appropriate location on the airport surface map to indicate the aircraft's approximate location. The local controller can transfer control of a FDE to the ground controller by selecting the FDE and then selecting the ground button 25 as shown in FIG. 2. In the preferred embodiment, transferring an arrival FDE to the ground controller causes the FDE to appear with gray text and border on the local controller's EFDI and with white text and border on the ground controller's EFDI.

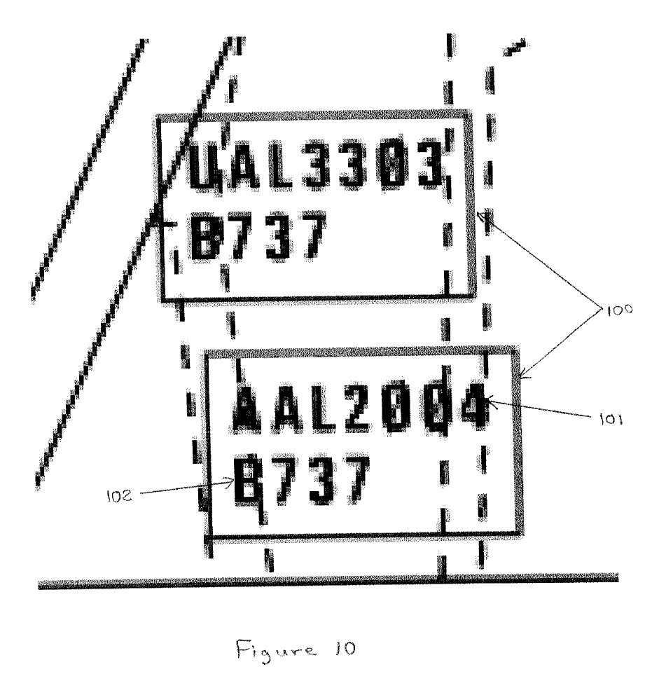

Once the local controller transfers an arrival FDE to the ground controller, the FDE becomes an inbound FDE. As shown in FIG. 10, an inbound FDE 100 shows only the flight data attributes of aircraft call sign 101 and aircraft type 102. In the preferred embodiment, inbound FDEs appear with white text and border on the ground controller's EFDI and with gray text and border on the local controller's EFDI. The ground controller can transfer inbound FDEs to a ramp controller or AOC by selecting a FDE and then selecting the ramp button.

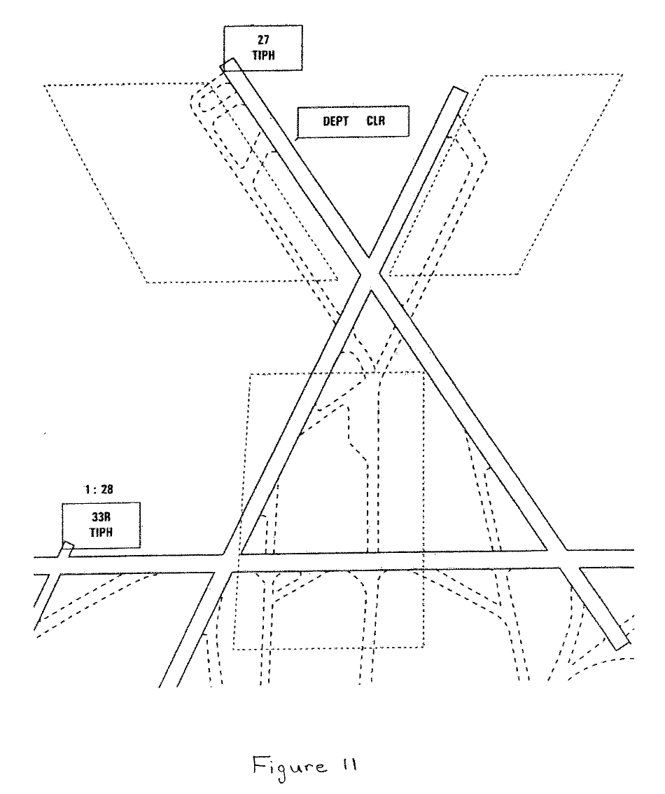

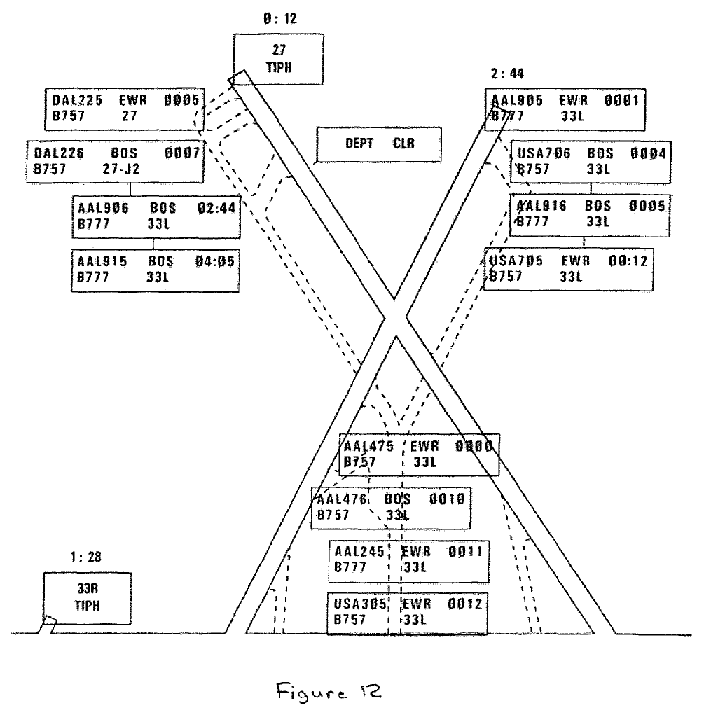

As shown in FIG. 11, there are three designated zones on the airport surface map where the P-S EFDI links FDEs together in a chain to maintain stacks of FDEs. One zone is located on the common taxiway leading to the primary departure runways. This zone is located short of the active runways and will contain FDEs possessed by both the ground and local controllers. The other two zones are located on the taxiways on the opposite side of the active runways. Each of these two zones leads directly to the respective departure end of the runways and typically contain only FDEs possessed by the local controller. The zones are not visible to the controller. However, when the controller moves a FDE into one of the zones, the FDE will display a stem on top of the FDE to indicate that the FDE is in a zone. If a controller moves a FDE into one of these zones, the FDE will become part of a chain as shown FIG. 12 when the controller releases it. The first FDE in a chain occupies an anchor position at the top of the zone. When the controller breaks a FDE chain by moving a FDE that is part of a chain, the remaining FDEs in the chain automatically move up the chain to close gaps, as appropriate, and the FDE at the front of the chain occupies the anchor position. This allows the controller to remove an FDE from a chain or to resequence the FDEs in a chain.

As shown in FIG. 2, the readout area 22 is located in the upper left corner of the airport surface map 20. Three different types of information may appear in the readout area; full flight data for an arriving aircraft, full flight data for a departing aircraft, or a list of the most recent FDEs transferred to another controller or facility.

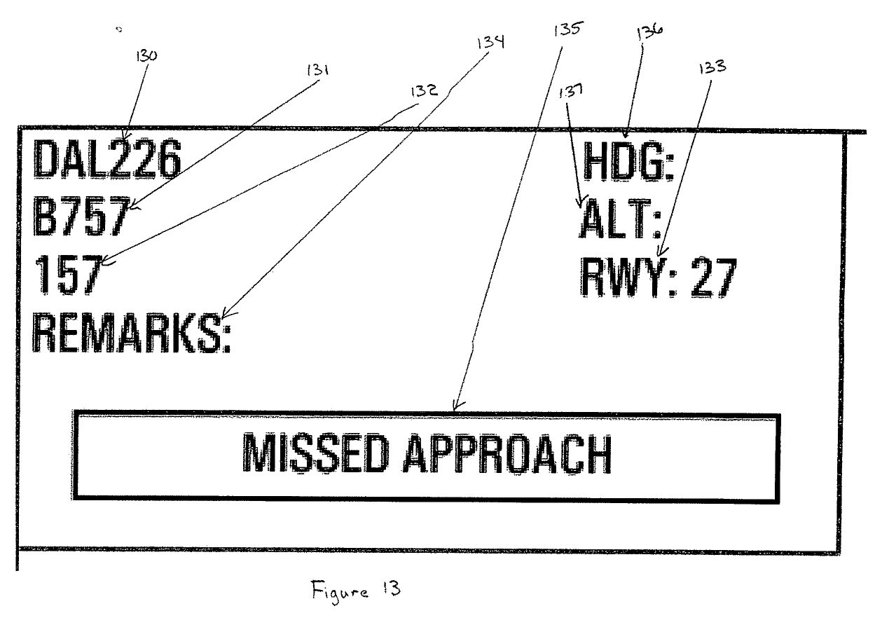

When the controller selects a FDE, the full set of flight data attributes appears in the readout area. Different attributes appear depending on whether the associated aircraft is an arriving or departing flight. As shown in FIG. 13, when the controller selects an arriving aircraft's FDE, the aircraft's call sign 130, type 131, computer identification (CID) 132, runway assignment 133, assigned heading 136 and altitude 137 if any, and remarks 134 appear in the readout area. For arriving aircraft, the readout area also contains a missed approach button 135. When the controller selects the missed approach button, the flight data system automatically assigns a standard altitude and heading in the aircraft's flight data information based on the aircraft's runway assignment.

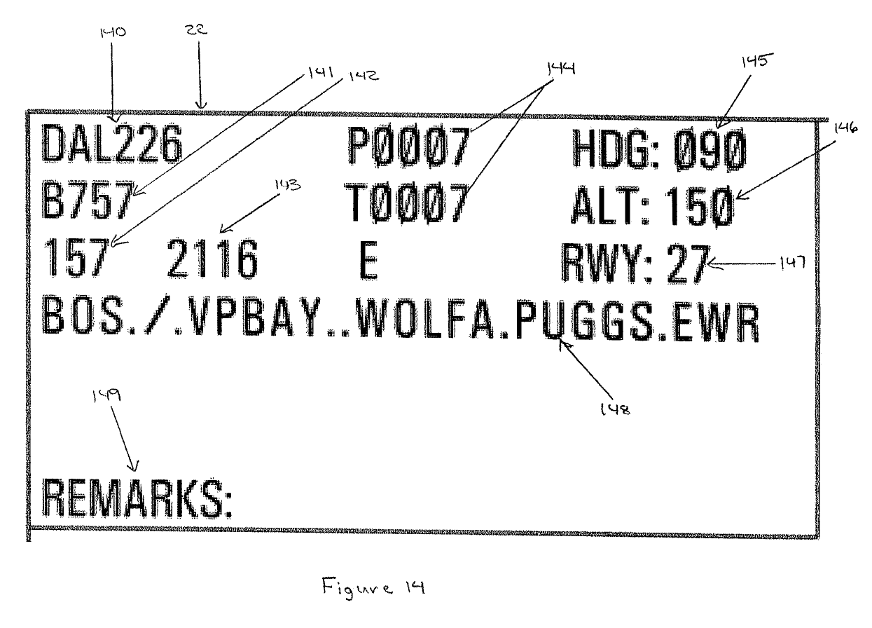

As shown in FIG. 14, the readout area 22 for departing aircraft works in the same general way as the readout area for arriving aircraft. The primary difference is that departing aircraft have more flight data attributes than arriving aircraft. When the controller selects a departing aircraft's FDE, the readout area 22 displays the aircraft's call sign 140, type 141, CID 142, beacon code 143, proposed departure time, taxi time, and EDCT 144, assigned heading 145, assigned altitude 146, assigned runway and intersection departure 147, route of flight 148, and remarks 149.

The readout area can also show a history of recent FDEs that a controller transferred to another position or facility. For example, the ground controller can display in the readout area the last four FDEs transferred to the local controller by selecting the local controller button. When the ground controller selects the local controller button, the FDEs appear muted in the readout area. The ground controller may recall any of the FDEs displayed in the readout area by selecting the FDE and then selecting a list header to place the FDE in the top of that list. Likewise, the local controller can recall an FDE from either the ground controller or the TRACON controller in the same manner. The local controller can select either the ground or TRACON header to see a list of the most recently transferred FDEs in the readout area. The local controller then selects an FDE and the appropriate list header to place the FDE at the top of that list.

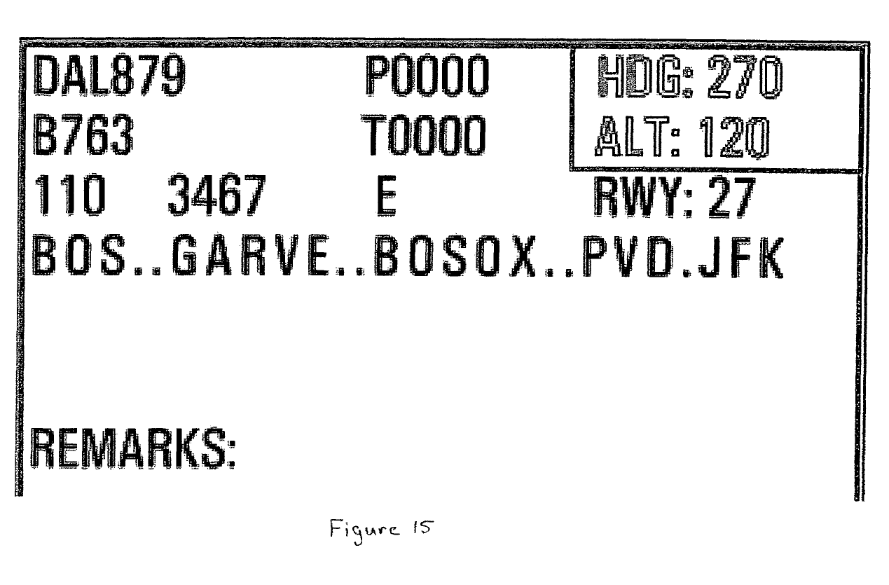

When the controller selects a FDE or data block, they may change the altitude or heading assignment by typing “a” for altitude or “h” for heading followed by a three-digit number and the “Enter” key. The controller can change both the altitude and the heading assignments at the same time by linking the commands. For example, when the controller selects an FDE or data block and the flight data appears in the readout area, the controller can type “a120h350” and press the “Enter” key to change the altitude assignment to 12,000 feet and the heading assignment to 350 degrees. The controller can link the commands in the opposite order to obtain the same result. The controller may include spaces, but entries that violate the syntax rule or exceed the range of possible values return an “Invalid Entry” message to the preview area on the airport surface map. When a controller changes an altitude or heading assignment, an asterisk will appear on the right hand side of the aircraft's FDE and appears highlighted in the readout area as shown in FIG. 15. When a controller transfers the FDE to another controller, the asterisk notifies the receiving controller that there has been a change to either the altitude or the heading assignments. The controller can select the FDE displaying the asterisk and examine the flight data in the readout area. The changed flight data attributes appear highlighted until the controller acknowledges the change by touching the highlighted information in the readout area. Acknowledging the change turns off the highlighting in the readout area and removes the asterisk from the FDE.

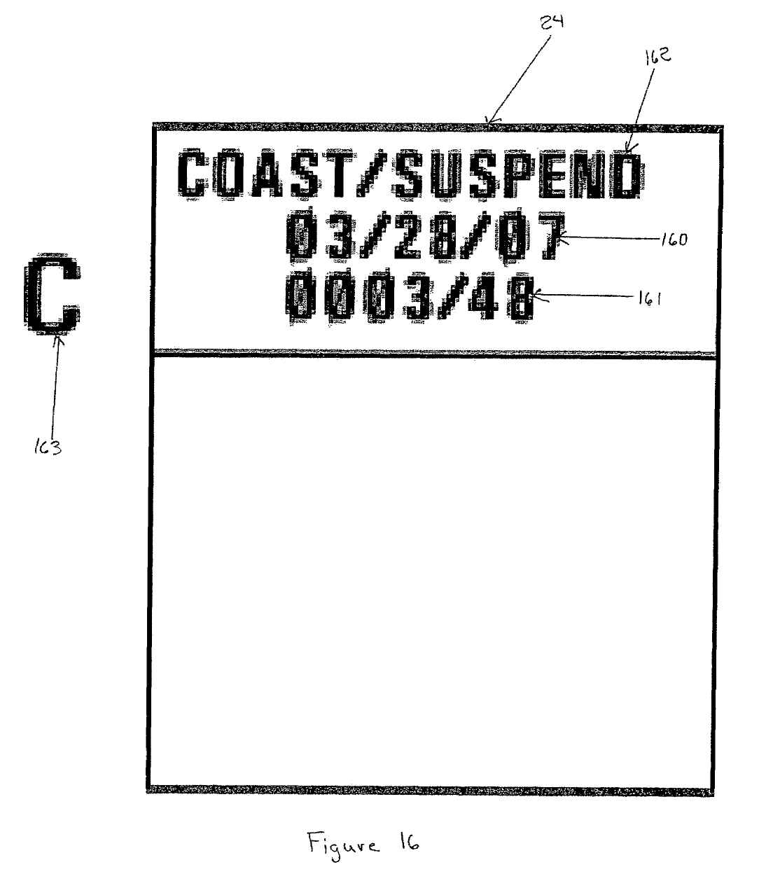

As shown in FIGS. 2 and 16, the system information window 24 is transparent and is located on the airport surface map 20. The system information window 24 contains the current date 160, time displayed in hours, minutes, and seconds UTC 161, and current ATIS code 163. The controller can place the system information window anywhere within the airport surface map 20. The controller cannot place the system information window over the FDEs or the readout area.

The ATIS is a continuous broadcast of recorded or automated non-control information. The ATIS usually updates about once an hour, but may update more often when special circumstances arise or when weather conditions change rapidly. Controllers must use a procedure on initial contact with an aircraft to verify that the pilot has the most recent ATIS information. If the pilot does not have the most recent information, the controller will provide it or request the pilot get it before receiving any further air traffic control clearances.

The current ATIS code 163 as shown in FIG. 16 works by alerting the controller whenever the ATIS changes. An ATIS change automatically causes the ATIS code 163 to flash near the system information window 24. In the preferred embodiment, the ATIS code appears yellow for 1.5 seconds and then white for 1.5 seconds for a total duration of 15 seconds. The controller can acknowledge the ATIS change by touching the flashing ATIS code 163, at which time the ATIS code stops flashing and displays normally, in the preferred embodiment, gray. If the controller does not acknowledge the ATIS change after 15 seconds, the ATIS code stops flashing and is displayed in yellow. The ATIS code remains displayed in yellow until the controller acknowledges the ATIS change by touching the ATIS code 163 near the system information window 24.

In addition to alerting the controller to ATIS updates, the P-S EFDI also indicates which aircraft to advise of the change. As shown in FIG. 3, the FDE appears with a box indicator 36 in the lower right corner of the FDE. This indicator reminds the controller to ensure that the pilot of the aircraft has the current ATIS information. Once the controller provides the current ATIS information to the pilot, the controller touches the box indicator in the FDE to make it disappear. The ATIS update indicator will reappear when a new ATIS code is generated.

What is claimed is:

1. In an air traffic control system including a processor, memory, source of electronic flight data, a touch sensitive display device, keyboard, trackball/keypad, a method to track, record, communicate, and organize electronic flight data spatially in relation to an airport surface comprising the steps of:
displaying an airport surface as an airport surface map on said touch entry display device;
displaying flight data information as a color coded fight data element on said airport surface map;
associating said flight data element with an aircraft's location on said airport surface map;
moving said flight data element by touching and dragging said flight data element to a desired location on said airport surface map;
displaying only necessary said color coded flight data information for a particular operation;
displaying full flight data information for an aircraft in a readout area;
using a set of touch activated buttons displayed on said airport surface map to change an aircraft's runway assignment, intersection assignment, or other flight data attributes, to indicate a TIPH or departure clearance, and to transfer flight data between controller positions and air traffic facilities;
designating zones on said airport surface map where said flight data elements be linked together in a chain;
using a system information window on said airport surface map to display the current date, time, and Automatic Terminal Information Service (ATIS) code; and
using a set of reminders that include an ATIS update status indication, generic and aircraft associated timers, generic and specific highlighted critical information, a taxi-into-position-and-hold indication, an aircraft associated runway spacing timer, aircraft delay status information, and an expected departure clearance time; and
linking ground controller and local controller displays such that changes made to a flight data element on one display is reflected on the other.

2. The method of claim 1, wherein the step of displaying flight data information as a color coded flight data element further comprises the steps of:
displaying a pending flight data element at a ground controller's position for a departing aircraft on said airport surface map at said aircraft's designated ramp spot, said pending flight data element contains flight data attributes comprising said aircraft's call sign, type, first departure fix, runway assignment, intersection assignment, proposed departure time or expected departure clearance time, ATIS update indicator, flight data update indicator, timer indicator, and delay status indicator;
displaying said pending flight data element as an outbound flight data element at said ground controller's position and said local controller's position for said departing aircraft when a ground controller moves said pending flight data element out of said ramp spot onto said airport surface map, said outbound flight data element contains flight data attributes comprising said aircraft's call sign, type, first departure fix, runway assignment, intersection assignment, assigned taxi time or expected departure clearance time, ATIS update indicator, flight data update indicator, timer indicator, and delay status indicator;
displaying said outbound flight data element as a departure flight data element at said local controller's position and said ground controller's position for said departing aircraft when a ground controller transfers said outbound flight data element, said departure flight data element contains flight data attributes comprising said aircraft's call sign, type, first departure fix, runway assignment, intersection assignment, assigned taxi time or expected departure clearance time, ATIS update indicator, flight data update indicator, timer indicator, runway spacing timer, and delay status indicator;
displaying an arrival flight data element for an arriving aircraft in an arrival list on said airport surface map at said local controller's position and said ground controller's position, said arrival flight data element contains flight data attributes comprising said aircraft's call sign, type, runway assignment, ATIS update indicator, flight data update indicator, and timer indicator; and
displaying said arrival flight data element as an inbound flight data element for said arriving aircraft on said airport surface map at said ground controller's position and said local controller's position when a local controller transfers said arrival flight data element to said ground controller, said inbound flight data element contains flight data attributes comprising said aircraft's call sign, type, flight data update indicator, and timer indicator.

3. The method of claim 2, wherein the step of displaying a departure flight data element for a departing aircraft at said local controller's position and said ground controller's position further comprises the steps of:
displaying a taxi-into-position-and-hold indication when said local controller selects a departure flight data element and selects an appropriate taxi-into-position-and-hold button;
recording a departure time for said departing aircraft when said local controller selects a departure flight data element and selects the departure clearance button;
displaying a runway spacing timer near the end of the departure runway and in the time field of the said departing aircraft's flight data element; and
displaying said departing aircraft's flight data element in a departure list located beneath an appropriate runway assignment button.

4. The method of claim 2, wherein the step of displaying an arrival flight data element for an arriving aircraft in an arrival list further comprises the steps of:
offsetting the display of flight data elements for aircraft assigned to land on different runways; and
dragging an arriving aircraft's flight data element to an appropriate location on said airport surface map at said local controller's position to indicate said aircraft's location on said airport surface.
